(19) United States
(12) Patent Application Publication
(10) Pub. No.: US 2012/0235365 A1
(43) Pub. Date: Sep. 20, 2012

(54) ALKY-ONE GASKET

(76) Inventors: Alan Stubblefield, Placentia, CA (US); David Walter Reeves, Orinda, CA (US)

(21) Appl. No.: 13/051,188

(22) Filed: Mar. 18, 2011

(51) Int. Cl. F16J 15/02

(52) U.S. Cl. 277/644

(57) ABSTRACT

A fluid sealing gasket is provided which comprises an outer guide ring, a serrated profile sealing element engaged to the outer guide ring and extending radially inward therefrom and an inner attachment ring engaged to the serrated profile sealing element and extending radially inward therefrom. An inner barrier pillow is formed about the inner attachment ring and extends radially inwardly therefrom. A graphite sealing element facing is formed about the serrated profile core, the serrated profile sealing element facing being disposed in abutting contact with the inner barrier pillow.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is directed to a gasket design for fluid sealing in severe acid environments, e.g., in alkalization plants.

Sealing gaskets have been used in a variety of different applications. The construction of such gaskets is typically a function of the application, the environment in which the gaskets are to be utilized, and other factors. Where gaskets are intended to be used in severe acid service environments the gasket constructions have included spiral wound gaskets incorporating carbon steel outer guide rings, windings made of Monel® and Teflon, or flexible graphite, and inner rings of Teflon, faced Teflon-coated carbon steel or Monel. Generally, the gasket winding has a metal (normally carbon rich or stainless steel) wound outwards in a circular spiral (other shapes are possible) with a filler material (generally a flexible graphite) wound in the same manner wound in the same manner but staring from the opposite side. This results in alternating layers of filler and metal. The filler material in these gaskets acts as the sealing element, with the metal providing structural support. Such gaskets have proven to be reliable in most applications, and allow lower clamping forces than solid gaskets, albeit with higher costs. While such spiral wound gaskets are generally suitable for use in severe acid environments, they have encountered a variety of shortcomings.

One such shortcoming relates to pooling of acid in the inside diameter of the flange area Whether the ring itself is manufactured from Teflon, faced Teflon-coated carbon steel, or Monel, such pooling can contribute to the degradation of the flange itself.

Further, Teflon inner ring gaskets have been found to be sensitive to external temperature variations. At cold temperatures, the Teflon inner rims may disassociate the outer guide rings, and fall out of the gasket. During hotter periods, the Teflon inner rings, which may require a relatively high minimum seating stress (i.e., 15,000 psi), can severely distort or cup. Spiral wound versions of such gaskets are also susceptible to breakage of the sealing element in response to over compression. Spiral wound gaskets have also been noted to have a relatively high leakage rate (e.g., 500 ppm), which is problematic in severe acid service applications. Additionally, Teflon filler materials used in spiral wound gaskets are not fire safe.

As described more fully below, the present invention is directed to an alkalization gasket that addresses these and other concerns.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front perspective view of a fluid sealing gasket in accordance with the present invention;

FIG. 2 is a top view of the gasket shown in FIG. 1;

FIG. 3 is a sectional view (lithe gasket;

FIG. 4 is an enlarged sectional view of a portion of the gasket shown in FIG. 3;

FIG. 5 is a cut away view of the gasket;

FIG. 6 is a chart indicating the performance of one embodiment of the invention:

FIG. 7 is a graph depicting the performance of one embodiment of the invention, in relation to a spiral wound gasket; and

FIG. 8 is a graph depicting the performance of one embodiment of the invention, at a different seating stress, in relation to a spiral wound gasket.

### BRIEF SUMMARY OF THE INVENTION

A fluid sealing gasket is provided which comprises an outer guide ring, a solid serrated sealing element engaged to the outer guide ring and extending radially inward therefrom and an inner guide ring engaged to the serrated sealing element and extending radially inward therefrom. A barrier pillow is formed about the inner attachment ring and extends radially inwardly therefrom. A graphite sealing element facing is formed about the serrated sealing element, the serrated sealing element facing being disposed in abutting contact with the inner barrier pillow.

The fluid sealing gasket defines a gasket width, in, wherein the outer guide ring extends approximately 30% of the gasket width, wherein the serrated sealing element which includes the serrated core facing extends approximately 38% of the gasket width, wherein the inner attachment ring extends approximately 16% of the gasket width and wherein the inner barrier pillow extends approximately 32% of the gasket width.

In the presently preferred embodiment the outer guide ring is formed of carbon steel, and the serrated sealing element and inner attachment ring is formed of an alloy including nickel, copper and iron, e.g., Monel™. The serrated sealing element facing is preferably formed of a flexible graphite material, such as APX 2 graphite, and the inner barrier pillow is preferably formed of expanded PTFE.

In the presently preferred embodiment the serrated sealing element and the inner attachment ring are formed from a single, uninterrupted body of metallic alloy material.

In the presently preferred embodiment a fluid sealing gasket is formed to have a cross-section of progressively decreasing thickness, wherein the inner barrier pillow is approximately 0.25 inches thick, the flexible graphite facing is approximately 0.020 inches thick and the outer guide ring is approximately 0.03125 inches thick. Correspondingly, the cross-section of the fluid sealing gasket is characterized by areas of progressively higher minimum seating stress, where the expanded PTFE inner barrier pillow exhibits a minimum seating stress of approximately 5,000 psi and the serrated element's minimum eating stress is approximately 12.500 psi. However, the serrated element is typically designed for a minimum seating load of 22,000 psi and can support a maximum seating load of 26,000 psi when using recommended installation procedure.

The presently preferred embodiment of the invention has been found to exhibit a low leakage rate, i.e., approximately 1 ppm, when compared to conventional spiral wound gaskets which have been found to have much higher leakage rates, i.e., approximately 500 ppm.

In the presently preferred embodiment the material for the serrated core file facing, APX 2 graphite is specified to provide a fire safe seal at up to 850° F.

In the presently preferred embodiment the barrier pillow is attached to the inner sealing element by machining a groove into barrier pillow to receive the inner guide ring. The groove is preferably formed to be approximately 0.40 inches wide and approximately 0.20 inches deep.

### DETAILED DESCRIPTION OF THE PRESENTLY PREFERRED EMBODIMENT

The description below sets forth the presently preferred embodiment of the invention in relation to the described application. It is to be understood, however, that various other embodiments of the invention may be implemented for the described application, and other applications, without departing from the broader aspects of the present invention.

Referring to the drawings, the presently preferred embodiment of fluid sealing gasket 10 is illustrated. As shown in FIG. 1, the exterior surfaces of gasket 10 define an outer guide ring 11, serrated core profile sealing element 13 and inner barrier pillow 15. The serrated profile sealing core facing 13 and the inner barrier pillow 15 define a pair of fluid seals which, upon compression and normal use, provides an acid barrier and a fluid tight seal for the sealing gasket 10.

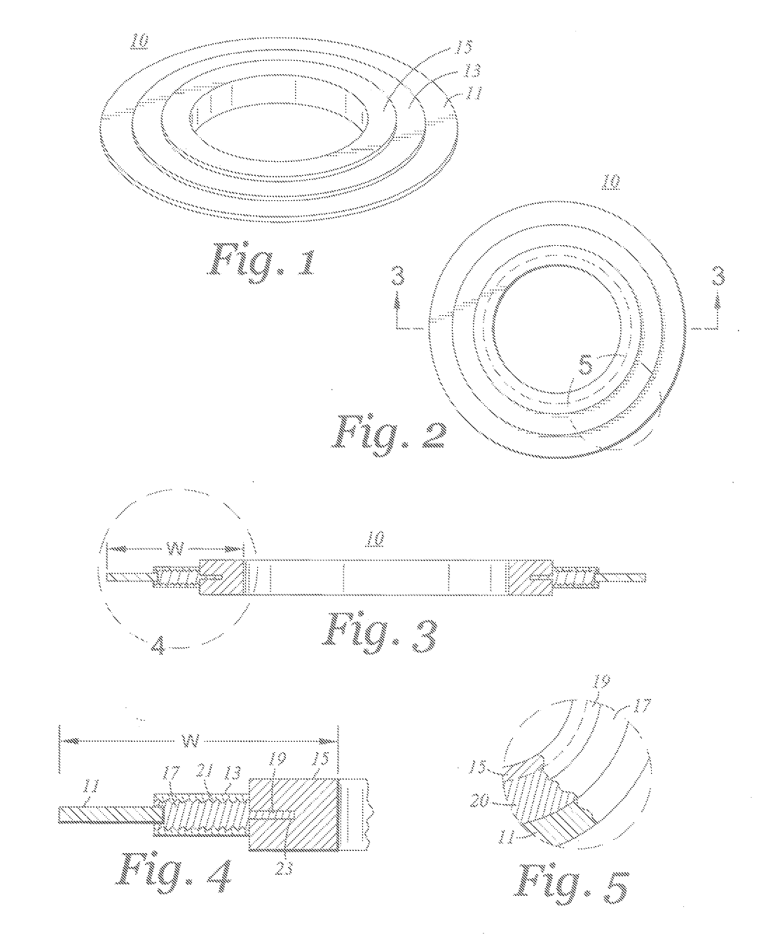

The interior construction of the gasket 10 is illustrated at FIGS. 3, 4, and 5. Referring to FIGS. 3 and 4, outer guide ring 11 is shown extending into serrated sealing core 17, which is formed to include serrated outer surface 21. The serrated profile and graphite facing sealing element 17 serves as a principle sealing element in the fluid sealing gasket 10.

Serrated profile gaskets are used in many seals due to exceptional scalability and reliable performance. These profiles work by having a solid serrated body, or core, with a flexible covering layer. The serrations minimize lateral movement of the facing material, while the metal alloy core provides rigidity and blowout resistance. This arrangement allows for a very high compression and an extremely tight seal along the ridges of the gasket.

The serrations concentrate load on a smaller area for a tight seal at lower stress. Under compression, the sealing material fills the surface imperfections to form a tight connection that can withstand extreme fluctuations in temperatures and pressures. The serrated profile gasket commonly handles pressures from vacuum to Class 2500, and withstands temperatures form cryogenics to 2000° F. (1090° C.)—depending on sealing material and metal.

The serrated profile gasket offers a safe, effective seal under the most exacting conditions on both standard pipe work and specialized applications. It offers excellent sealablity in recovery characteristics, allowing seal integrity under pressure and temperature fluctuations, temperature differentials across the flange face, flange rotation, bolt stress relaxation and creep.

Graphite sealing facing 13 extends about the serrated profile sealing element 17. Upon compression, the graphite lacing 13 is compressed against and fills in the recesses defined by the profile serrations 21.

Inner attachment ring 19 is engaged to and extends from the serrated profile sealing element 17. In the presently preferred embodiment, the serrated profile core 17 and inner attachment ring 19 are formed from a single piece of metallic alloy, such as the family of alloys sold under the Monel Trademark.

Monel is a Trademark of Special Metals Corporation for a series of nickel alloys, primarily composed of nickel (up to 67%) and copper, with some iron and other trace elements. Monel's good resistance against corrosion by acids and oxygen makes Monel a good material for use in highly corrosive environments. In the presently preferred embodiment Monel 400 is used in the construction of the serrated sealing element 17.

The inner expanded PTFE barrier pillow 15 envelops the inner attachment ring 19 and abuts against the serrated profile sealing element 17 and graphite facing 13. In the presently preferred embodiment the expanded PTFE barrier pillow 15 is formed of expanded polytetrafluoroethylene (PTFE).

The PTFE barrier pillow 15 includes a slot, or groove 23, which receives and seals against the inner attachment ring 19, isolating the ring 19 and scaling element 17 from corrosive chemicals, to prevent damage to ring 15 due to chemical intrusion and pooling against the sealing element 17.

PTFE is a synthetic fluoropolymer of tetrafluoroethylene that finds numerous applications. PTFE is most well known by the Dupont brand name. Teflon®. PTFE is very non-reactive, partly because of the strength of the carbon-flouroene bonds, so it is often used in containers and pipe work for reactive and corrosive chemicals. PTFE has one of the lowest frictions against any solid, and its melting point is reported to be approximately 327° C. (621° F.), but its mechanical properties can degrade above 200° C. (500° F.).

Upon compression of the gasket 10, the inner expanded PTFE barrier pillow 15 and the graphite facing 13 are compressed to a substantially coplanar orientation to provide dual sealing regions about the gasket 10.

As shown in FIGS. 3 and 4, in the presently preferred embodiment, the fluid sealing gasket 10 defines a gasket width, which extends 1.1525 inches. The outer guide ring 11 extends approximately 30% of the gasket width. The serrated profile sealing element 17 extends approximately 38% of the gasket width. The inner attachment ring 19 extends approximately 32% of the gasket width. Consequently, serrated profile in accordance with the present invention the main sealing element of the gasket, i.e. the sealing element, extends over less than half of the gasket area, which allows an increase in the amount of gasket stress that can be applied to the gasket. The size and location of the serrated profile sealing element also mitigates buckling problems and breaking associated with conventional spiral-wound gaskets that contain Teflon inner rings, and enhances the ability of the gasket to compensate for relaxation that may occur.

FIG. 6 is a chart indicating the performance of one embodiment of the invention, identified as the Alky-One gasket, where the flange bolts are torqued to 150 psi. The chart indicated the performance of the embodiment over a range of different pipe sized, number of bolts, bolt dimensions and gasket dimensions. The chart provides the stress values resulting from use of the Alky-One gasket in association with different sized pipes.

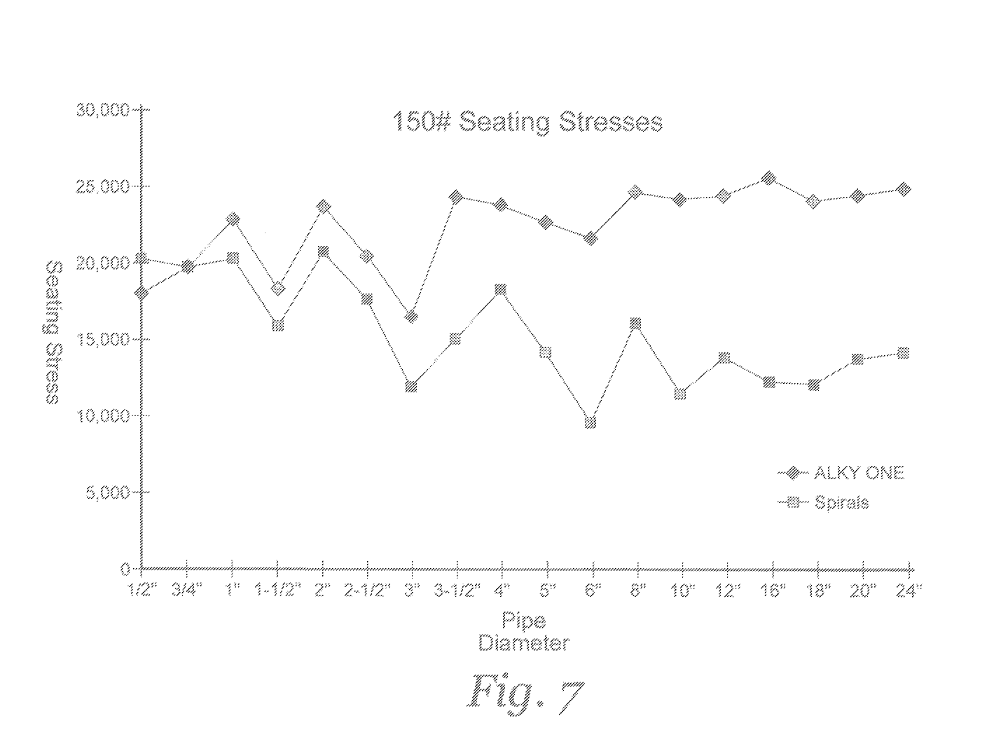

FIG. 7 is a graph depicting the performance of the invention in relation to the performance of a spiral wound gasket, where a 150 lb. psi seating stress is applied to each bolt, over a range of different pipe diameters. The graph depicts information taken from the chart of FIG. 6. For comparison purposes, the graph also depicts the seating stress measured in a spiral wound gasket where the same 150 lb. psi bolt seating stress is applied, over a range of pipe diameter. Comparison and the performance of the Alky-One gasket to the performance of the spiral wound gasket, indicates that stress values obtained through use of the Alky-One gasket are typically greater than the stress values obtained through the use of the spiral wound gasket, particularly in larger pipe diameters. Average seating stress values obtained in the Alky-One gasket are up to approximately 53% greater than the average seating stress values obtained using the spiral wound gasket, for the same bolt-up torque values.

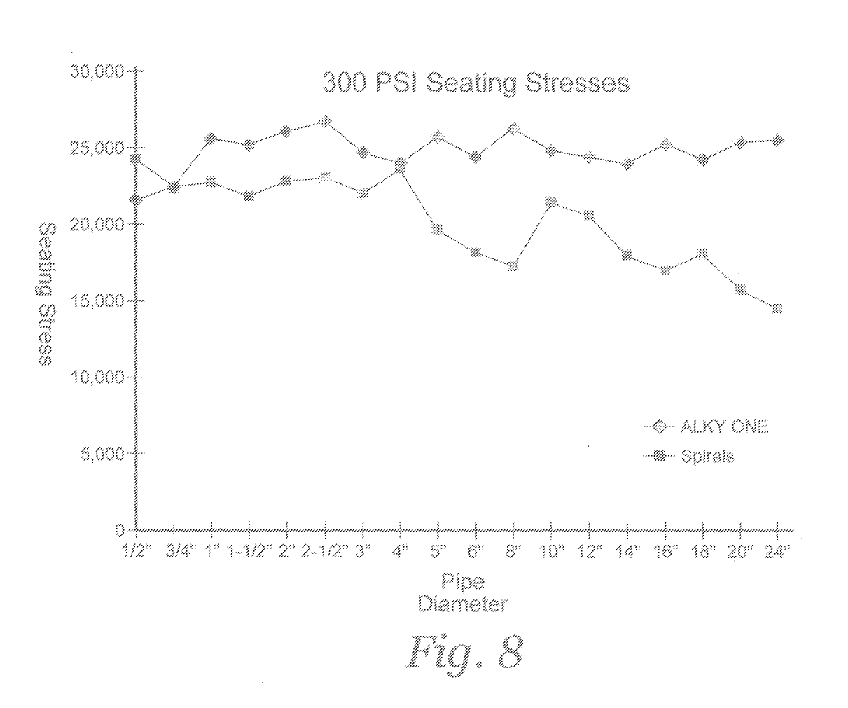

FIG. 8 is a graph depicting the performance of the Alky-One gasket and a spiral wound gasket, over a range of pipe diameters, where the bolts are torqued to a 300 psi seating stress. As shown in FIG. 8, the average stress values on the Alky-One gasket are typically measured to be substantially higher than the average seating stress values on the spiral wound gasket, particularly in the mid to higher pipe diameters. Measurements indicate that the average seating stress values for the Alky-One gasket are approximately 26% greater than the average seating stress values of the spiral wound gasket, using the same bolt-up torque values.

As will be apparent to one of ordinary skill in the art, the specific materials used to form the invention, the dimensions of the product and other details of the invention may be modified without departing from the broader aspects of the invention. However, the construction details of the presently preferred embodiment are described below.

In the presently preferred embodiment the exposed portion of the outer guide ring extends approximately 0.3437 inches. The outer guide ring has a thickness of approximately 0.625 inches, and is preferably formed of carbon steel. An unexposed portion of the outer guide ring extends approximately 0.0625 inches into the serrated profile core. The outer guide ring has a thickness of approximately 0.125 inches

The serrated profile core extends approximately 0.4375 inches, having a thickness of approximately 0.125 inches. The serrated profile core is preferably formed of a Monel metallic alloy. The serrated profile core facing has a thickness of approximately 0.020 inches and is preferably formed of APX2 Graphite, i.e., a flexible graphite material. The facing extends along the serrated profile core.

The inner guide ring extends approximately 16% of the gasket width. i.e., approximately 16% of the gasket width, i.e. approximately 0.18565 inches. The inner guide ring is preferably formed to have a width approximately 0.03125 inches.

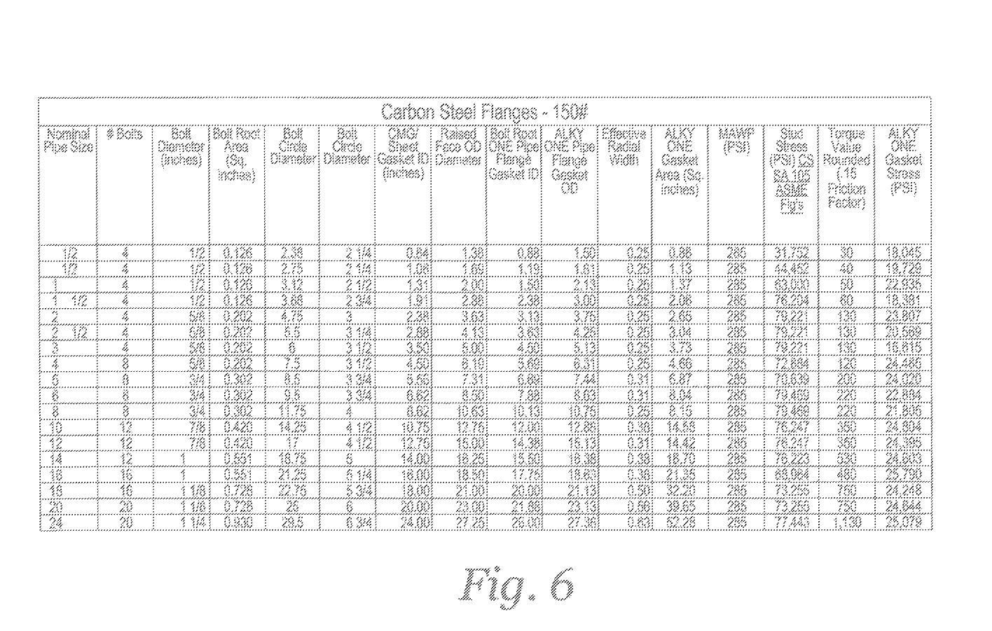

In the presently preferred embodiment, the inner guide ring and the serrated profile core may be formed as from a single, uninterrupted piece of Monel alloy material. FIG. 5 illustrates a construction wherein the serrated profile core and the inner guide ring are formed of a single piece of material 20, which extends into a portion of the inner guide ring facing 15. However in other constructions, the inner guide ring and the serrated profile core may be separately formed and connected.

The inner barrier pillow 15 preferably is formed to extend to approximately 32% of the width of the gasket, i.e., approximately 0.3713 inches. The barrier pillow has a width of approximately 0.250 inches, and defines a slot to receive the inner guide ring. The inner barrier pillow is formed preferably of expanded PTFE, which is machined and attached to the inner attachment ring/serrated profile body. In a process whereupon the barrier pillow is first machined and then attached to the inner attachment ring in a manner to assure that the barrier pillow resists separation or dislodging from the serrated sealing element inner attachment ring 19.

More particularly, as described in relation to FIG. 4, a groove or slot must is cut in the outer diameter of the PTFE barrier pillow ring. To do this, the harrier pillow is clamped between two machined metal tools that make up a clamping device that holds the barrier pillow by its inner diameter. The metal tool clamping device, with the barrier pillow clamped in it, is secured in a lathe, allowing a torque to be applied. While the metal clamping device and the barrier pillow are rotating about its center in the lathe, a sharp tool that cuts a groove into the barrier pillow's outer surface, shown in FIG. 4 as slot 23, that is approximately 0.040 inches wide and approximately 0.20 inches deep. After the groove has reached the desired depth, the sharp tool is backed out of the groove. The barrier pillow, with outer diameter groove, is then removed from the tooling. The inner attachment ring 19 is then inserted within the slot formed in the barrier pillow

What is claimed is:

1. A fluid sealing gasket comprising:
a. an outer guide ring;
b. a serrated profile sealing element engaged to the center guide ring and extending radially inward therefrom;
c. an inner attachment ring engaged to the serrated profile sealing element and extending radially inward therefrom;
d. an inner barrier pillow enveloping the inner attachment ring and extending radially inward therefrom; and
e. a graphite sealing facing formed about the serrated profile sealing element, the graphite sealing facing being in abutting contact with the inner barrier pillow.

2. The fluid sealing gasket as recited in claim 1, wherein the gasket defines a gasket width.

3. The fluid sealing gasket as recited in claim 2, wherein the gasket width is approximately 1.1525 inches.

4. The fluid sealing gasket as recited in claim 2, wherein the outer guide ring extends approximately 30% of the gasket width.

5. The fluid sealing gasket as recited in claim 4, wherein the outer guide ring is formed of carbon steel.

6. The fluid sealing gasket as recited in claim 5, wherein the outer guide ring is approximately 0.0625 inches thick.

7. The fluid sealing gasket as recited in claim 2, wherein the serrated profile sealing element extends approximately 38% of the gasket width.

8. The fluid sealing gasket as recited in claim 7, wherein the serrated profile core is formed of a Monel alloy.

9. The fluid sealing gasket as recited in claim 8, wherein the serrated profile core is approximately 0.125 inches thick.

10. The gasket sealing gasket as recited in claim 2, wherein the inner attachment ring extends approximately 16% of the gasket width.

11. The fluid sealing gasket as recited in claim 10, wherein the inner attachment ring is formed of Monel alloy.

12. The fluid sealing gasket as recited in claim 11, wherein the inner attachment ring is approximately 0.03125 inches thick.

13. The fluid sealing gasket as recited in claim 12, wherein the inner attachment ring and serrated profile sealing core are formed as a single piece of material.

14. The fluid sealing gasket as recited in claim 2 wherein the inner barrier pillow extends approximately 32% of the gasket width.

15. The fluid sealing gasket as recited in claim 14, wherein the barrier pillow is formed of expanded PTFE.

16. The fluid sealing gasket as recited in claim 15 wherein the inner expanded PTFE barrier pillow is approximately 0.25 inches thick.

17. The fluid sealing gasket as recited in claim 2, wherein the serrated profile sealing element facing extends approximately 38% of the gasket width.

18. A fluid sealing gasket as recited in claim 17, wherein the serrated profile sealing element facing is formed of flexible graphite material.

19. A fluid sealing gasket as recited in claim 18, wherein the serrated profile sealing element facing is approximate 0.020 inches thick.

20. The fluid sealing gasket as recited in claim 1, wherein the inner expanded PTFE barrier pillow defines a gasket inner radius.

21. The fluid sealing gasket as recited in claim 1 wherein the outer guide ring defines a gasket outer radius.

22. The fluid sealing gasket as recited in claim 1, wherein the gasket is operative to provide a gasket seating stress in excess of 25,000 psi when 150 ft. lbs. of seating stress is applied.

23. The fluid sealing gasket as recited in claim 1 wherein the gasket is operative to provide a gasket sealing stress in excess of 25.000 psi when 300 ft. lbs. of seating stress is applied.

24. The fluid sealing gasket as recited in claim 1 wherein the inner barrier pillow is machined to form a groove to receive the inner attachment ring.

25. The fluid sealing gasket as recited in claim 24 wherein the groove is approximately 0.40 inches wide.
